(19) United States
(12) Patent Application Publication
(10) Pub. No.: US 2013/0162486 A1
(43) Pub. Date: Jun. 27, 2013

(54) SWITCHABLE DIVERSITY ANTENNA APPARATUS AND METHODS

(71) Applicants: Heikki Korva, Tupos (FI); Ari Raappana, Kello (FI); Petteri Annamaa, Oulunsalo (FI)

(72) Inventors: Heikki Korva, Tupos (FI); Ari Raappana, Kello (FI); Petteri Annamaa, Oulunsalo (FI)

(21) Appl. No.: 13/333,588

(22) Filed: Dec. 21, 2011

(51) Int. Cl. H01Q 21/28; H01Q 21/30

(52) U.S. Cl. 343/725

(57) ABSTRACT

An active diversity antenna apparatus and methods of tuning and utilizing the same. In one embodiment, the active diversity antenna is used within a handheld mobile device (e.g., cellular telephone or smartphone), and enables device operation in several low frequency bands (LBs). The exemplary implementation of the active LB diversity antenna comprises a directly fed radiator portion and a grounded (coupled fed) radiator portion. The directly fed portion is fed via a feed element connected to an antenna feed. The coupled fed portion of the LB antenna is grounded, forming a resonating part of the low frequency band. A gap between the two antenna portions is used to adjust antenna Q-value. Resonant frequency tuning is achieved by changing the length of the grounded element. The LB feed element is disposed proximate the feed element of a high band diversity antenna, thus reducing transmission losses and improving diplexer operation.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The present invention relates generally to antenna apparatus for use in electronic devices such as wireless or portable radio devices, and more particularly in one exemplary aspect to a switchable diversity antenna operable in a lower frequency range, and methods of tuning and utilizing the same.

2. Description of Related Technology

Internal antennas are an element found in most modern radio devices, such as mobile computers, mobile phones, Blackberry® devices, smartphones, personal digital assistants (PDAs), or other personal communication devices (PCDs). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Radio devices operating indoor or in urban environment often experience performance degradation due to multipath interference or loss, especially when there is no clear line-of-sight (LOS) between a transmitter and a receiver. Instead, the signal is reflected along multiple paths before finally being received. Each of these “bounces” can introduce phase shifts, time delays, attenuations, and distortions that can destructively interfere with one another at the aperture of the receiving antenna.

Antenna diversity, one of several wireless diversity schemes that use two or more antennas to improve the quality and reliability of a wireless link, is especially effective at mitigating these multipath situations. This is because multiple receive antennas offer a receiver several observations of the same signal; each antenna signal experiences a different interference environment during propagation through the wireless channel. Collectively, multiple antenna system can provide a more robust link, compared to a single antenna solution.

The use of multiple diversity antennas invariably requires additional hardware (e.g., antenna radiator, connective cabling, and, optionally, matching circuitry), and may increase size of a portable radio communications device, which is often not desirable.

Various methods are presently employed to provide antenna diversity. High frequency range or band (HB) diversity antenna solutions are more readily obtained (due to primarily a smaller radiator required to operate at higher frequencies) without resulting in an increased device size.

One typical prior art low frequency band (LB) diversity antenna solution is presented in FIG. 1. The mobile device 100 comprises one or more main antennas (104, 106) and a low band passive diversity antenna 108. The area denoted by the line 114 in FIG. 1 depicts space reserved for a high band diversity antenna. The LB diversity antenna 108 comprises passive antenna structure, and is coupled to the mobile device feed port 112 via a shunt inductor matching to ground. The LB diversity antenna 108 configuration and placement (as shown in FIG. 1) provide the lowest envelope correlation in low frequency range, for example, 700-960 MHz. When using an additional parasitic element 110 (grounded at the point 122), the LB diversity antenna 108 is capable of covering two distinct operational bands in the low frequency range, for example Band VIII and Band XII of a Long Term Evolution (LTE) standard. However, presently available passive lower band diversity antenna solutions (i) cover a limited number of operating bands (single band without parasitic radiator element, or two bands with one parasitic radiator), (ii) are characterized by poor radiation efficiency of the parasitic radiator, and (iii) require long coaxial feed cables in order to combine low band and high band diversity antenna feeds. These long cables create antenna diplexer impedance mismatch which, in turn, causes additional electric resonances, and shifts the frequency of the antenna response as the electrical length of the feed connector varies.

In addition, monopole antennas, presently used for low band diversity, are susceptible to dielectric loading due to handling by users during host device operation.

Accordingly, there is a salient need for a spatial diversity antenna solution for e.g., a portable radio device with a small form factor, and which offers a lower complexity and improved robustness, as well as providing for improved control of antenna resonance during operation.

### SUMMARY OF THE INVENTION

The present invention satisfies the foregoing needs by providing, inter alia, a space-efficient diversity antenna apparatus, and methods of tuning and use thereof.

In a first aspect of the invention, diversity antenna apparatus is disclosed. In one embodiment, the apparatus is active and includes: a first antenna apparatus configured to operate in a first frequency range and comprising a first feed portion configured to be coupled to a feed structure of a radio device; and a second antenna apparatus configured to operate in a second frequency range, and comprising: a first radiator comprising a second feed portion configured to couple a radiating portion to the feed structure; a second radiator comprising a first portion and a second portion, the second portion configured to be coupled to a ground plane of the radio device; and selector apparatus configured to selectively couple the first portion to the ground plane. In one variant, the selector is configured to enable wireless communication of the radio device in at least two operational bands within the second frequency range.

In another variant, the second frequency range is lower in frequency than the first frequency range, and the first and second frequency ranges do not appreciably overlap in frequency.

In a further variant, the at least two operational bands comprise bands specified by a Long Term Evolution (LTE) wireless communications standard.

In yet another variant, the selector apparatus comprises a switch, such as e.g., a single pole, multi-throw switch.

In another variant, the coupled feed configuration enables the diversity antenna apparatus to be substantially insensitive to dielectric loading during device operation; and

In another embodiment, the diversity antenna apparatus comprises a directly fed radiator portion and a grounded (coupled fed) radiator portion. The directly fed portion is fed via a feed element coupled to an antenna feed (e.g., at the center of the ground plane edge). The coupled fed portion of the antenna is grounded, forming a resonating part of the low frequency band. A gap between the two antenna portions is used to adjust antenna Q-value. Resonant frequency tuning is achieved by changing the length of the grounded element. The low band feed element is disposed proximate feed element of a high band diversity antenna, thus reducing transmission losses and improving diplexer operation.

In a second aspect of the invention, a mobile communications device is disclosed. In one embodiment, the device comprises a cellular telephone or smartphone which includes the active diversity antenna apparatus discussed supra.

In another embodiment, the mobile device includes: an enclosure comprising a plurality of sides; an electronics assembly comprising a ground plane and at least one feed structure; a main antenna assembly configured to operate in a lower frequency range and an upper frequency range and disposed proximate a bottom side of the plurality of sides; and a diversity antenna assembly disposed along a lateral side of the plurality of sides, the lateral side being substantially perpendicular to the bottom side.

In one variant, the diversity antenna assembly includes: a first diversity antenna apparatus configured to operate in the high frequency range and comprising a first feed portion coupled to the feed structure; and a second diversity antenna apparatus configured to operate in the lower frequency range, and comprising: a first radiator comprising a second feed portion configured to couple a radiating portion to the feed structure; a second radiator, comprising a ground structure coupled to the ground plane; and a selector element configured to selectively couple a selector structure of the second radiator to the ground plane. The selector element is configured to enable wireless communication of the mobile communication device in several (e.g., at least four) operational bands within the lower frequency range.

In another variant, the ground structure is disposed proximate one end of the second diversity antenna apparatus; and the second feed portion is disposed proximate a second end of the second diversity antenna apparatus, the second end disposed opposite from the first end.

In yet another variant, the second feed portion is disposed proximate the first feed portion.

In another variant, the second feed portion and the first feed portion are each coupled to a feed port via a feed cable; and proximity of the second feed portion to the first feed portion is configured to reduce transmission losses in the feed cable. The feed cable comprises for instance a microstrip conductor, or a coaxial cable.

In another variant, the selector structure is disposed in-between the second feed portion and the ground structure.

In still a further variant, the selector element comprises a switching apparatus characterized by a plurality of states and configured to selectively couple the selector structure to the ground plane via at least four distinct circuit paths, and at least one of the distinct circuit paths comprises a reactive circuit.

In a third aspect of the invention, active low band diversity antenna apparatus is disclosed. In one embodiment, the apparatus includes: at least first and second radiating elements; and a coupled feed configuration. The coupled feed configuration enables the diversity antenna apparatus to be substantially insensitive to dielectric loading during device operation; and the antenna apparatus is configured to operate over several spaced bands of a lower frequency range required by a wireless communication network standard.

In one variant, the standard comprises a Long Term Evolution (LTE) standard, and the several spaced bands are selected from the B17, B20, B5, B8, and B13 bands thereof.

In another variant, the apparatus further includes switching apparatus in operative communication with the at least first and second radiating elements and configured to alter the resonant frequency of the antenna apparatus.

In another aspect of the invention, a low frequency range diversity antenna is disclosed which comprises: a coupling element; a first radiating element being adapted for direct coupling to a feed structure of a portable device via the coupling element; and a second radiating element being adapted for connection to a ground plane via at least one ground point. The diversity antenna is fed via the coupling element, and a resonating portion of the low band diversity antenna is formed by grounding a part of the antenna.

In another aspect of the invention, a method of operating a diversity antenna apparatus is disclosed. In one embodiment, the antenna apparatus is for use in a portable radio device, and the method includes selectively switching an element of the antenna apparatus so as to operate the apparatus over several spaced bands of a lower frequency range.

In a fourth aspect of the invention, a method of mitigating the effects of user interference on a radiating and receiving diversity antenna apparatus is disclosed.

In a fifth aspect of the invention, a method of tuning a diversity antenna apparatus is disclosed.

Further features of the present invention, its nature and various advantages will be more apparent from the accompanying drawings and the following detailed description.

### BRIEF DESCRIPTION OF THE DRAWINGS

The features, objectives, and advantages of the invention will become more apparent from the detailed description set forth below when taken in conjunction with the drawings, wherein:

FIG. 1 is an isometric view of a mobile device low band passive diversity antenna implementation of the prior art.

FIG. 2A is a top plan view of a mobile device showing one embodiment of an active low band diversity antenna apparatus according to the invention.

FIG. 2B is a cross-section view of the mobile device embodiment shown in FIG. 2A taken along line A-A, detailing the high frequency band diversity antenna installation.

FIG. 2C is an isometric view of the mobile device of FIG. 2A, detailing the active low band antenna apparatus thereof.

FIG. 2D is a top perspective view of a side portion of the mobile device of FIG. 2A, showing a detail of the structure of the active low band diversity antenna apparatus of FIG. 2C.

FIG. 2E is a top perspective view of a side portion of the mobile device of FIG. 2A, showing detailed structure of the high band diversity antenna apparatus of FIG. 2C.

FIG. 3 is a schematic diagram detailing one embodiment of a switching circuit for use with the active antenna apparatus shown in FIG. 2B.

FIG. 3A is a top plan view of the side portion of the mobile device shown in FIG. 2E illustrating the use of the active switching circuit of FIG. 3 according to one embodiment of the invention.

FIG. 4 is a plot of load impedance seen by antenna element measured at the switch pad of the diversity antenna radiator of the exemplary antenna apparatus shown in FIG. 2C.

FIG. 5 is a graphical representation of data related to a simulated surface current obtained for the diversity antenna radiator of the exemplary antenna apparatus shown in FIG. 2C.

FIG. 6 is a plot presenting data related to free space input return loss measured with an exemplary multiband antenna apparatus configured in accordance with the invention.

FIG. 7A is a plot presenting data related to total free space efficiency measured with an exemplary low frequency diversity antenna configured in accordance with the invention.

FIG. 7B is a plot presenting data related to total free space efficiency measured with an exemplary low frequency main antenna apparatus configured in accordance with the invention.

FIG. 8A is a plot presenting data related to free space envelope correlation measured with (i) a passive prior art diversity antenna; (ii) exemplary low band active diversity antenna of the embodiment of FIG. 3A configured to operate in the B17 frequency band; and (iii) exemplary low band active diversity antenna of the embodiment of FIG. 3A configured to operate in the B8 frequency band.

FIG. 8B is a plot presenting simulation data related to free space total input efficiency and envelope correlation obtained for the following antenna apparatus configurations: (i) a passive prior art diversity antenna; (ii) exemplary low band active diversity antenna of the embodiment of FIG. 3A configured to operate in the B17 frequency band; and (iii) exemplary low band active diversity antenna of the embodiment of FIG. 3A configured to operate in the B8 frequency band.

All Figures disclosed herein are © Copyright 2011 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any apparatus or system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna or portion thereof.

The terms “RF feed,” “feed,” “feed conductor,” and “feed network” refer without limitation to any energy conductor(s) and coupling element(s) that can transfer energy, transform impedance, enhance performance characteristics, and conform impedance properties between an incoming/outgoing RF energy signals to that of one or more connective elements, such as for example a radiator.

As used herein, the terms “loop” and “ring” refer generally and without limitation to a closed (or virtually closed) path, irrespective of any shape or dimensions or symmetry.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), TD-LTE, analog cellular, CDPD, satellite systems such as GPS, millimeter wave or microwave systems, optical, acoustic, and infrared (i.e., IrDA).

### Overview

The present invention provides, in one salient aspect, an active low band diversity antenna apparatus for use in a mobile radio device. The antenna apparatus advantageously provides improved radiation efficiency, and enables device operation in several distinct frequency bands of the low frequency range, as compared to prior art solutions. A coupled feed antenna configuration makes the diversity antenna substantially insensitive to dielectric loading during device operation.

In one embodiment, the low frequency range diversity antenna comprises two radiating elements. The first radiating element is directly coupled to the feed structure of the portable device electronics via a coupling element disposed at center of the ground plane edge. The second radiating element is connected to ground at a ground point

The diversity antenna is fed via the coupling element, and the resonating part of the low band diversity antenna is formed by grounding a part of the antenna, which produces an antenna envelope correlation coefficient that is similar to an antenna apparatus having the feed point next to main antenna feed point.

The lowest envelope correlation coefficient (ECC) is achieved in the exemplary embodiment when the antenna feed point is disposed along lateral center axis of the ground plane, while the grounding point is located proximate to main antenna at the bottom of the device. ECC increases as the feed point is moved from center of ground plane towards the top of the ground plane.

The distance (gap) between the directly fed radiator and the grounded coupled feed radiator elements is used in one embodiment to adjust antenna Q-value. Resonant frequency tuning is achieved by changing electric length of the grounded element.

Antenna tuning is further achieved by adding a second branch to the grounded radiator element configured to selectively connect (via a switch) the grounded radiator element to a switch contact close to antenna ground point. Different impedances can be used on different output ports of the switch to enable selective tuning of the diversity antenna in different operating bands in the lower frequency range. In one implementation, tuning of the antenna's lowest operating band is achieved when the switch is in an open state (corresponding to high impedance). Respectively, tuning in the highest operating frequency band is enabled when the switch is in a closed position (corresponding to low or ground impedance).

The diversity antenna solution of the invention advantageously enables operation across multiple frequency bands of interest; for example, in all low frequency receive bands (i.e., the bands B17, B20, B5 and B8) currently required by E-UTRA and LTE-compliant networks. Also, operation in B13 is possible by replacing one of the currently presented bands, or by using an SP5T switch (B13 is used in CDMA devices which usually don't require coverage of other LTE bands, which are related to GSM/WCDMA devices).

Compared to a passive design, the antenna feed point of the exemplary embodiments of the invention can be disposed closer to the high band diversity element feed point. This advantageously reduces transmission line loss, and stabilizes diplexer behavior (a diplexer is typically required to combine LB and HB diversity elements into single feed point). The HB element is in one embodiment implemented as a separate element due to better achievable bandwidth within a small antenna volume.

The coupled feed (loop type antenna) arrangement for low band diversity implemented by certain embodiments of the invention is also insensitive to dielectric loading by a user's hand, as compared to monopole type passive diversity antennas which are not. Methods of operating and tuning the antenna apparatus are also disclosed.

### Detailed Description of Exemplary Embodiments

Detailed descriptions of the various embodiments and variants of the apparatus and methods of the invention are now provided. While primarily discussed in the context of mobile devices, the apparatus and methodologies discussed herein are not so limited. In fact, many of the apparatus and methodologies described herein are useful in any number of complex antennas, whether associated with mobile or fixed devices (such as e.g., base stations or femtocells), cellular or otherwise.

### Exemplary Antenna Apparatus

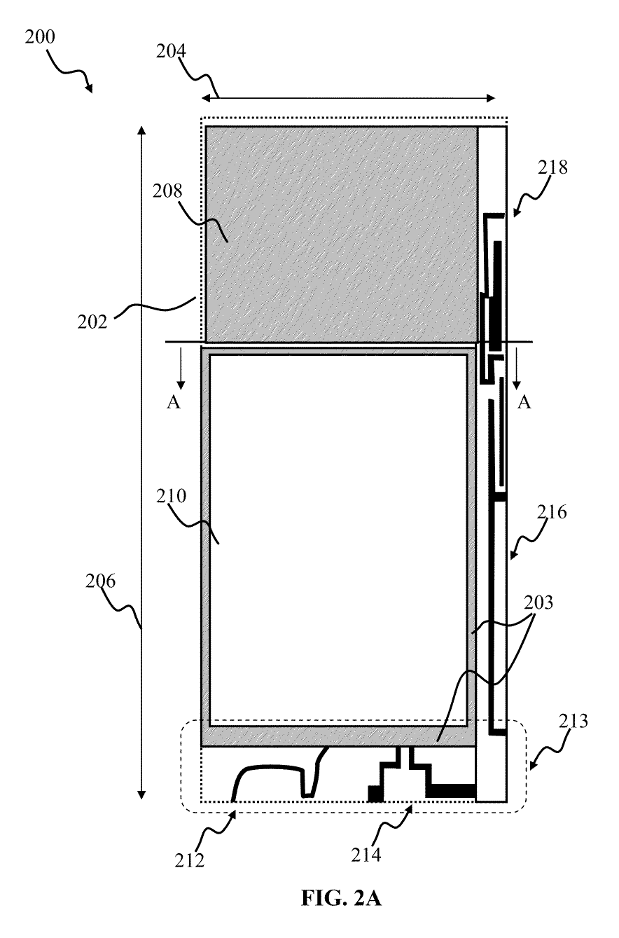

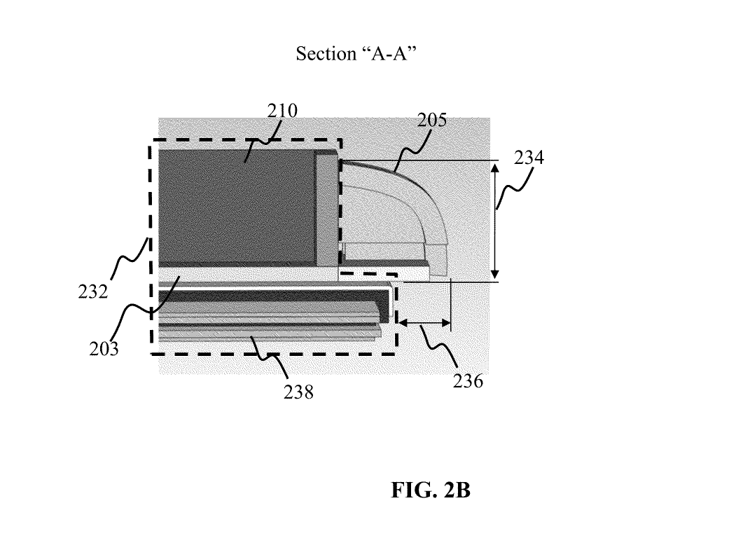

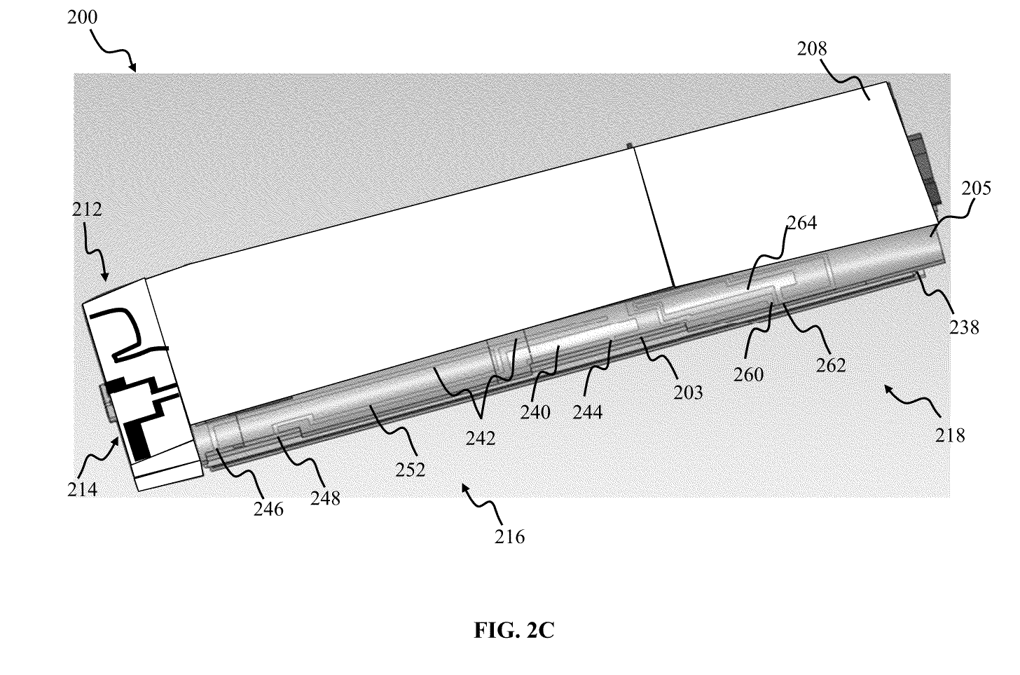

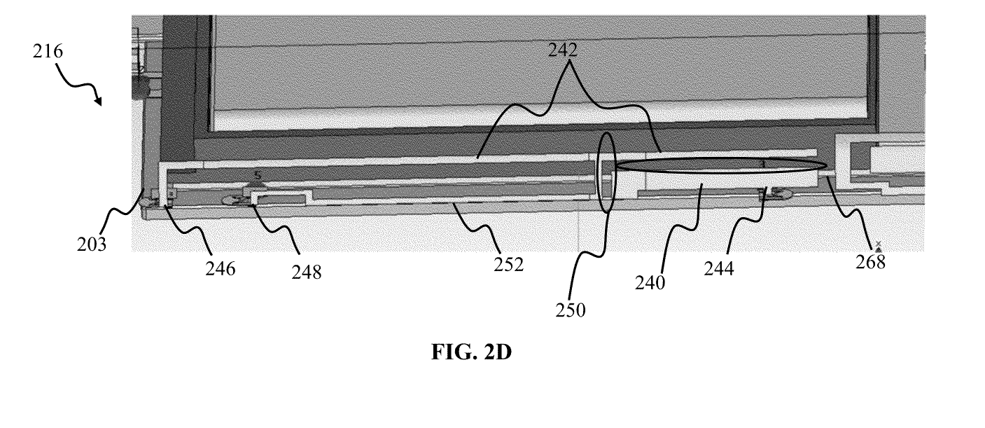

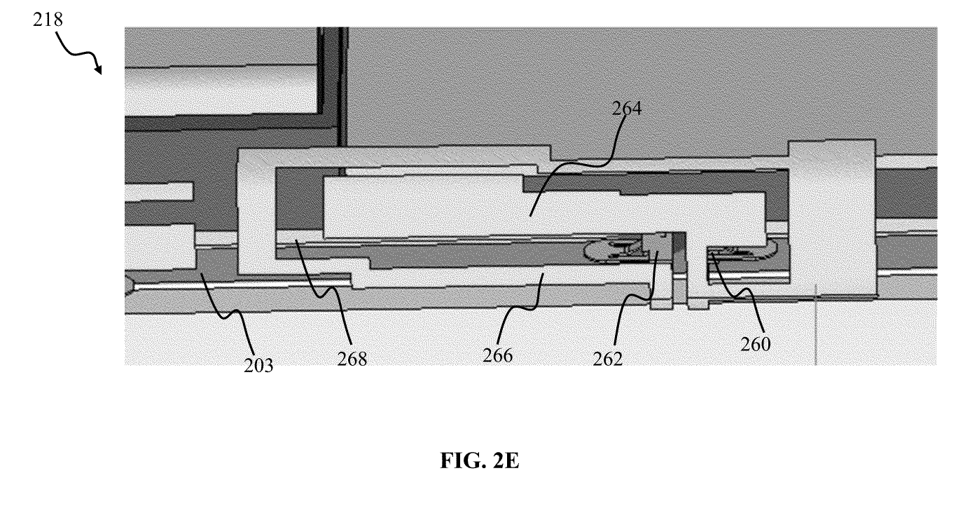

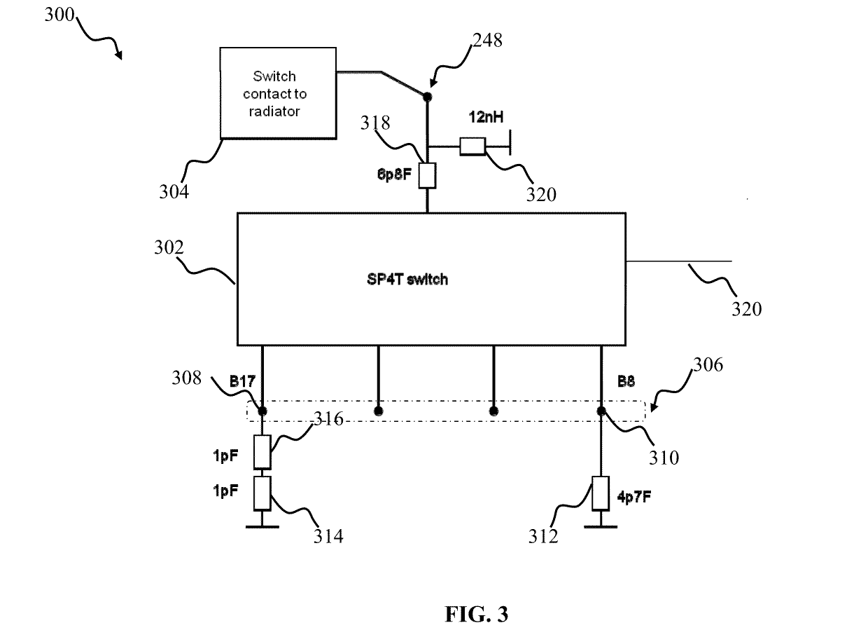

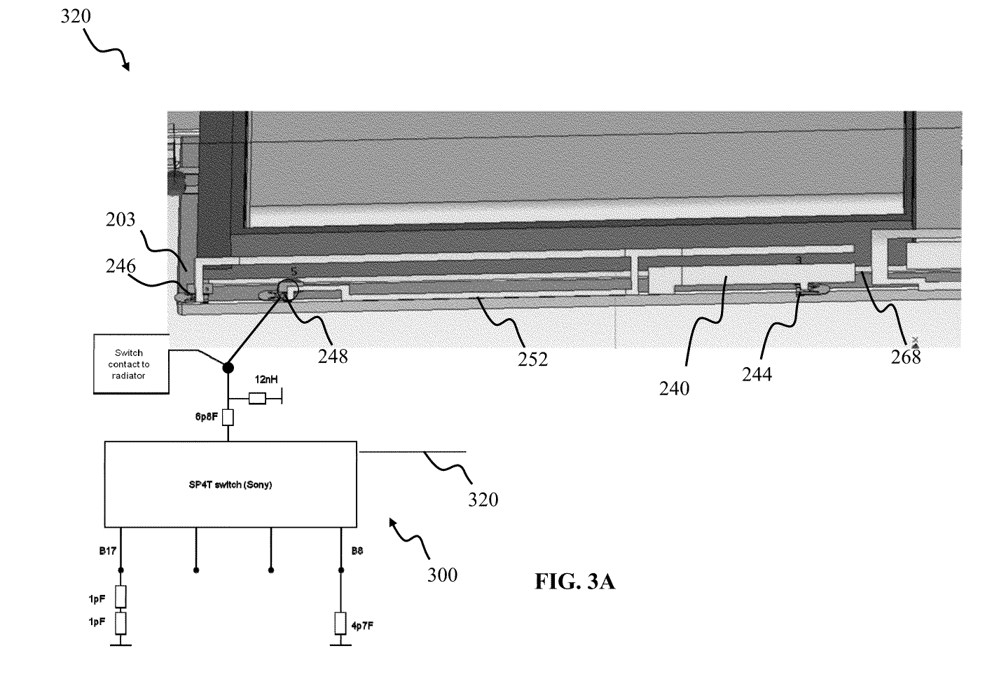

Referring now to FIGS. 2 through 3B, embodiments of the radio antenna apparatus of the invention are described in detail. One exemplary embodiment of the antenna apparatus for use in a mobile radio device is presented in FIG. 2A, showing a top plan view of a mobile communications device 200 with the antenna apparatus installed therein. The device 200 comprises an enclosure 202 (having a longitudinal dimension 206 and a transverse dimension) and containing a battery 210 and a transceiver printed wired board (PWB) 208. The device 200 further comprises a ground plane 203. The PWB 208 may, in one implementation, be a part of the device main PWB. The housing 202 may be fabricated from a variety of materials, such as, for example, suitable plastic or metal, and supports a display module. In one variant, the display comprises a touch-screen or other interactive functionality. Notwithstanding, the display may comprise e.g., a display-only device configured only to display information, a touch screen display (e.g., capacitive or other technology) that allows users to provide input into the device via the display, or yet other technology.

The PWB of the device 200 is coupled to the device and the antenna assembly, the latter comprising several antennas: (i) low frequency (LB) main antenna 212; (ii) high frequency (HB) main antenna, 214; (iii) low frequency (LB) diversity antenna 216; and (iv) high frequency diversity antenna 218. In one variant (such as shown in FIG. 2A), the two main antennas 212, 214 are disposed proximate a bottom edge of the device ground plane 203, while the two diversity antennas are disposed along a vertical edge of the ground plane 203. In another variant, the locations of the main and diversity antennas are reversed. It will be appreciated by those skilled in the arts given the present disclosure that other spatial antenna configurations are exemplary and different confirmations may be used, such as, for example, any placement on mobile device ground plane where diversity antenna element has feed point next to main antenna feed point and antennas are aligned substantially perpendicular to each other (e.g. respective ground plane edges) so that the antennas form an angle of or close to 90 degrees between the main and diversity antenna pairs.

By way of background, the main antenna (e.g., the antenna 212, 214 of FIG. 2A) of a portable radio device is typically configured to both transmit and receive RF signals on all operating bands of the device. The diversity antenna (e.g., the antenna 216, 218 of FIG. 2A) is configured to operate only in receive mode, and is required to cover only one receive (RX) frequency band at a time. Typically, the diversity antenna comprises a narrower band of operation as compared to the main antenna. While the main antenna communicates (transmits and receives) data with the base station via one propagation channel, the diversity antenna is receives same signal from the base station via a second propagation channel. When, for example, the first propagation channel is disturbed, the second propagation channel is used to deliver signals to the device. Such configuration provides spatial redundancy, and may also be used to increase data throughput of the overall downlink from bases station to mobile device. In one implementation, the signals propagating on the two propagation channels have different polarizations, thus creating redundancy via polarization diversity.

FIG. 2B shows a portion of the mobile device 200 cross-section “A-A” illustrating spatial constrains for diversity antenna placement that are imposed by a typical wireless device mechanical construction. In order to reduce the overall device width, it is desirable to implement diversity antenna radiators without increasing the device housing overall dimensions. Diversity antenna placement options are further restricted by the various metal components of the portable device 200, such as for example, the ground plane 203, the display 238, and the battery 210. The dashed line denoted by 232 in FIG. 2B envelops the area of the exemplary device containing metal components, thus illustrating the limited amount of space that is available for the diversity antennas 216, 218. The antenna frame 205 in FIGS. 2B-2C (typically fabricated from plastic) is configured to support antenna radiators.

In the implementation illustrated in FIGS. 2A, 2C, the device housing 202 is 125 mm (5 in.) in length and 68 (2.7 in.) in width, and the available ground clearance 236 below the diversity antennas is about 2.8 mm (0.1 in.), with the maximum width of the diversity antenna being limited by the dimension 234, which is about 5.7 mm (0.2in.).

In order to reduce the size occupied by the diversity antennas, the low band and the high band antennas 216, 218 are implemented using separate radiator elements.

Referring now to FIGS. 2C-2E, the structure of the diversity antennas 216, 218 is shown and described in detail. FIG. 2C presents an isometric view of the mobile device 200 with the back cover and a portion of the device enclosure 202 being removed for viewing. The LB diversity antenna 216 is disposed along a vertical side of the device enclosure 202 proximate location of the main antenna 214. The low frequency range diversity antenna 216 comprises two radiating portions 240, 242. The first radiating portion 240 is directly coupled to the diversity antenna feed structure 268 of the portable device electronics via a feed element 244 disposed at center of the ground plane 203 edge. The second radiator element 242 comprises a linear branch connected to the ground plane via the ground structure 246. The diversity antenna 216 is fed via the coupling element 224, and the resonating part of the low band diversity antenna is formed by grounding the radiator portion 242 of the antenna. The diversity antenna configuration illustrated in FIG. 2C produces antenna envelope correlation coefficient (ECC) that is similar to an antenna apparatus having the feed point next to main antenna feed point.

The lowest ECC is achieved when the antenna feed point is disposed along the lateral center axis of the ground plane, while the grounding point is located proximate to the main antenna at the bottom of the device. ECC increases as the feed point is moved from center of ground plane towards the top of the ground plane.

The distance (gap) 250 shown in FIG. 2D between the two radiator portions 222 and 220 can be used to adjust the antenna Q-value. Resonant frequency tuning is achieved by adjusting the length of the grounded element 242.

LB diversity antenna 216 tuning to a particular operating frequency band is further achieved in one embodiment by adding a second branch 252 to the grounded radiator element 242. The branch 252 is selectively coupled to the ground plane 203 via a switch (shown and described in detail with respect to FIG. 3 below) at a ground switch point 248. The electrical length of the grounded radiator element 242, 252, is varied by changing the amount of current that passes through the radiator arm connected to switch circuit. When the switch is open (corresponding to high impedance at the switch port, when looking from the radiator towards the PCB), most of the current to pass through the solid ground connection, which has low impedance. As the current travels a longer distance, the electric length of the grounded element is increased, thereby lowering the antenna resonance frequency.

Conversely, when the switch is closed, the switch contact has low impedance to ground thus causing most of the current to pass through the switch contact, thereby tuning the antenna resonance to its highest frequency.

The coupled feed (loop type antenna) configuration used to implement the low band diversity antenna 216 is insensitive to dielectric loading by a user's hand, as compared to a typical prior art monopole type passive diversity antenna solution, which does suffer from such sensitivity.

The HB diversity antenna 218 of the illustrated embodiment comprises radiating element 264 that is coupled to the diversity feed structure 268 via a feed element 262, and a loop structure 266 coupled to the ground plane via the ground structure 262.

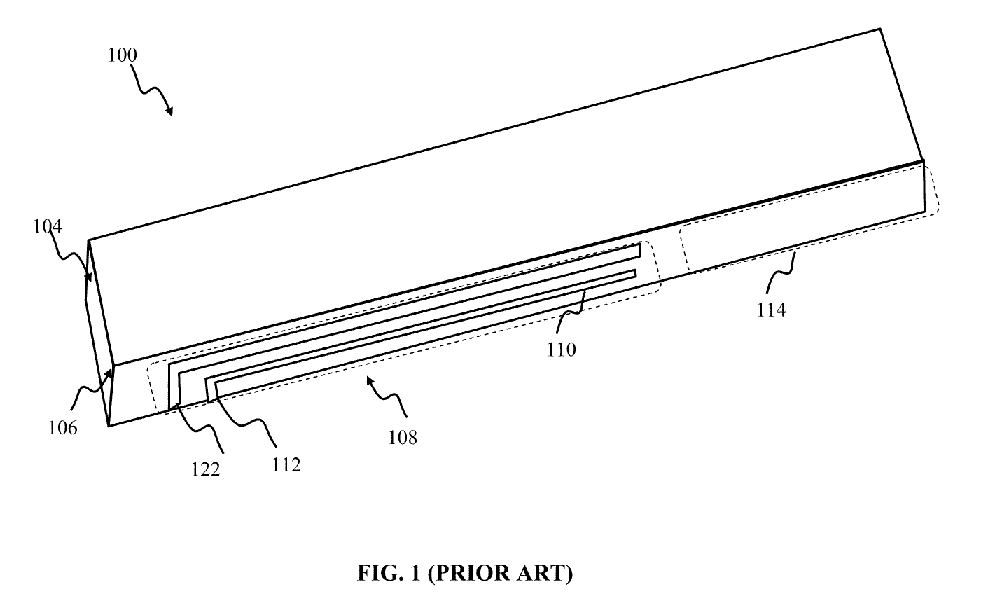

Compared to passive diversity antenna design shown in FIG. 1, the feed element 244 of the active the diversity antenna 216 is moved substantially closer to the feed element 262 of the LB diversity antenna. Close proximity of the diversity feeds 244, 262 reduces transmission line loss in the diversity feed structure 268, and stabilizes diplexer behavior (a diplexer is typically required to combine LB and HB diversity elements into single feed point). The diversity feed structure in one variant of the invention comprises a conductive trace disposed on the PWB dielectric. In another variant, the diversity feed structure 268 is implemented via a coaxial cable or other conductor.

Although the diversity antennas 216, 218 share the common feed structure, the use of separate radiators for HB and LB diversity antennas enables the optimization of antenna bandwidth/available space trade-offs, and achieving the widest diversity bandwidth in the smallest antenna volume.

Furthermore, in some embodiments of the invention, the diversity antenna may practically be placed anywhere within the mobile device provided that (i) the feed point of the diversity antenna is proximate to the main antenna feed; and (ii) the two antennas are aligned perpendicular to one other (e.g., respective ground plane edges, where the antennas are placed so as to form an angle on the order of 90°).

FIGS. 3-3A illustrate one exemplary embodiment of a switching apparatus useful with the low band diversity antenna 216 described supra with respect to FIGS. 2C-2D. The switch apparatus 300 comprises a single pole-four throw switch 302 configured to selectively couple the radiator switch point 304 to the ground plane via any of the four output ports 306. The switch point 248 is coupled to the antenna branch 252 as illustrated in FIG. 3A. A tuning network comprising a capacitor 318 and an inductor 320 is configured to adjust the impedance that is seen by the antenna, thereby enabling antenna tuning to the desired frequency band of operation.

In one implementation, the switch 302 comprises a GaAs SPT4 solid-state switch. As is appreciated by those skilled in the arts given this disclosure, other switch technologies and/or a different number of input and output ports may be used according to design requirements. The switch 302 is controlled via a control line 320 coupled to the device logic and control circuitry.

Different impedances can be used on different output ports of the switch 302 (such as the ports 308, 310 in FIG. 3) in order to enable selective tuning of the diversity antenna in different operating bands in the lower frequency range. In one implementation, tuning of the antenna lowest operating band is achieved when the switch is in an open state (corresponding to high impedance). Respectively, tuning in the highest operating frequency band is enabled when the switch is in a closed position (corresponding to low or ground impedance).

The diversity antenna solution of the embodiment of FIG. 3B advantageously enables operation in all low frequency receive bands (e.g., the bands B17, B20, B5 and B8) currently required by LTE-compliant mobile devices. As a brief aside, the frequency band designators used herein in describing antenna embodiments of FIGS. 2A-3B refer to the frequency bands described by the 3^{rd} Generation Mobile System specification “LTE; Evolved Universal Terrestrial Radio Access (E-UTRA); User Equipment (UE) radio transmission and reception, (3GPP TS 36.101 version 9.8.0 Release 9)”, incorporated herein by reference in its entirety.

In one variant, the LB diversity antenna of FIG. 3B may be adapted to operate in the B13 low frequency band, frequently employed by CDMA networks, by replacing one of the currently presented bands (i.e., the bands B17, B20, B5 and B8). Although the B13 band is used in CDMA devices which typically do not require coverage of other LTE bands, in another variant, the B13 band may be implemented using a five output SP5T switch in place of the SP4T switch 302, thus enabling mobile device operation in five lower frequency range bands B17, B20, B5, B8, and B13 using a single LB diversity antenna.

### Performance

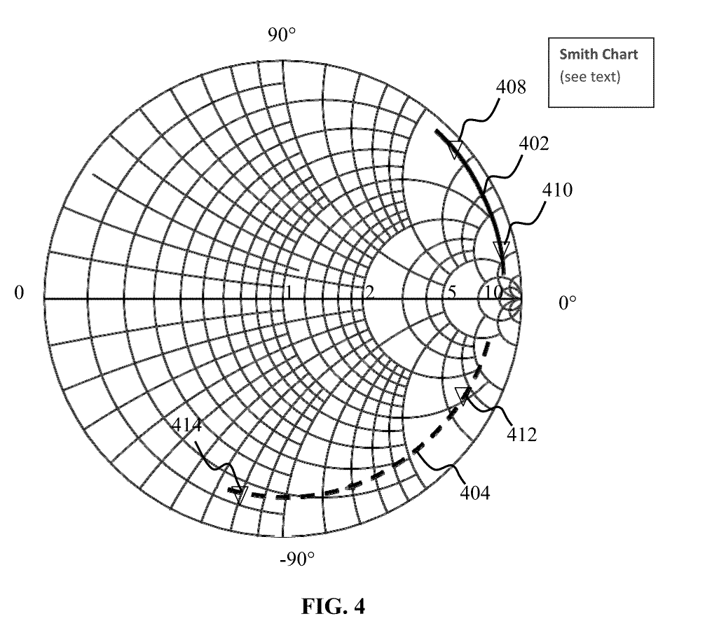

FIGS. 4 through 8B present performance results obtained during simulation and testing by the Assignee hereof of an exemplary antenna apparatus constructed according to one embodiment of the invention.

FIG. 4 shows a polar phase diagram of load impedances measured at the LB diversity antenna switch pad (e.g., the switch pad 248 of FIG. 2D). The curve denoted by the designator 402 corresponds to the measurements taken with the antenna operating in the frequency band 17 (the switch 312 of FIG. 3A in B17 state); the curve denoted by the designator 404 corresponds to the measurements taken with the antenna operating in the frequency band 8 (the switch 312 of FIG. 3A in B8 state).

Table 1 summarizes measurement data corresponding to the triangles marked with the designators 408-412. Data shown in FIG. 4 and Table 1 confirm load impedance phase shift of about 180° deg when the LB diversity antenna operates in the B17 frequency band, as compared to the antenna operating in B8 frequency band. Furthermore, the data in Table 1 show a higher input impedance when the switch is in the B17 position, compared to the B8 position. The lower antenna input impedance in B8 band corresponds to higher currents through the antenna switch contact and causes a frequency shift (tuning) of the antenna operating band towards higher frequencies within the low frequency range of the antenna.

TABLE 1

| | FIG. 4 | | Impedance | Impedance |
|---|---|---|---|---|
| State | designator | Frequency [MHz] | Magnitude | Angle [deg] |
| 17 | 408 | 740 | 2.6 | 85.7 |
| 17 | 410 | 942 | 11.5 | 65 |
| 8 | 412 | 740 | 4.1 | −71.6 |
| 8 | 414 | 942 | .8 | −79 |

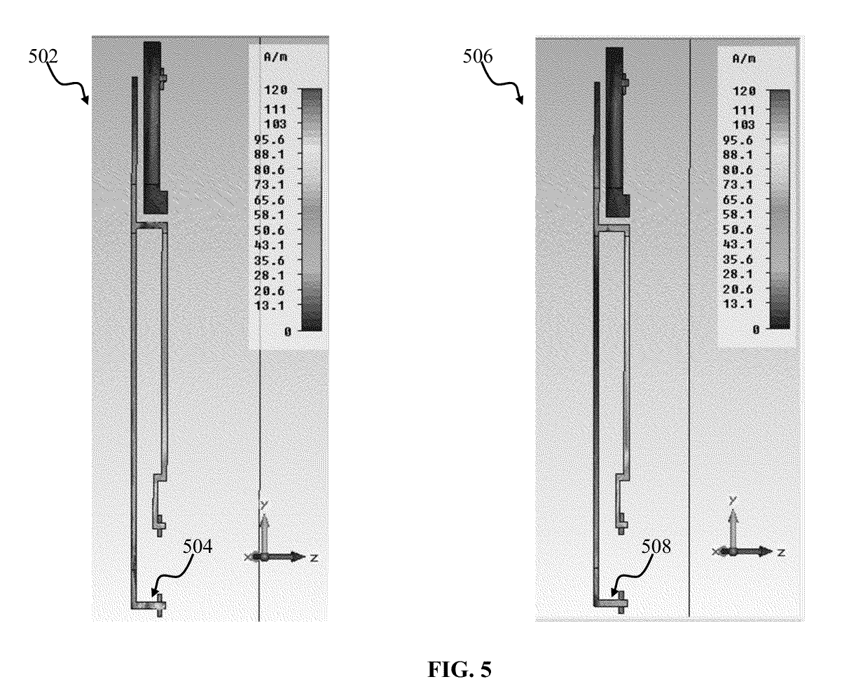

FIG.S. 5A-5B present data related to simulated surface currents on diversity antenna radiator 240, 242 of the antenna embodiment of FIG. 3A. The data in FIG. 5A correspond to the switch 310 position of band B17, and show that most of the current flows through the ground contact 246. These data indicate that the electrical length of antenna 216 is determined by the radiator element 242, and comprises the whole longitudinal extent. The data in FIG. 5B are obtained with the antenna switched to operate in the band B8, and show that B17 most of the current flows through the switch contact 248. The data in FIG. 5B indicate that the effective length of the LB diversity radiator is reduced, and is determined by the length of the auxiliary switching branch 252.

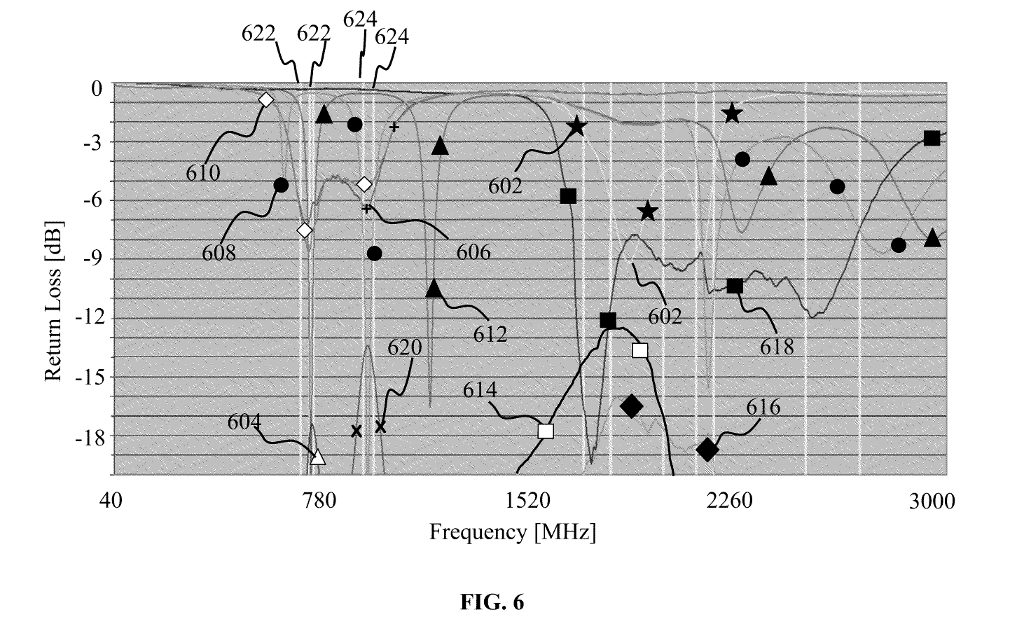

FIG. 6 presents data related to return loss in free space (FS) measured with the antenna apparatus comprising the LB main antenna 212, HB main antenna 214, LB diversity antenna 216, and HB diversity antenna 218 constructed according to the exemplary embodiment of FIG. 2A. The solid lines designated with the designators 622, 624 mark the boundaries of frequency bands B17 and B8, respectively. The curves marked with designators 602-620 correspond to measurements obtained in the following antenna configurations:

(i) curve 602—LB diversity antenna 216 in B 17 RX state and HB diversity antenna 218;

(ii) curve 604—LB diversity antenna 216 in B 17 RX state, and LB main antenna with isolation in free space;

(iii) curve 606—main antenna 212, 214, LB diversity antenna 216 in B17 RX state;

(iv) curve 608—LB diversity antenna 216 in B8 RX state and HB diversity antenna 218;

(v) curve 610—main antenna 212, 214, LB diversity antenna 216 in B17 RX state;

(vi) curve 612—LB diversity antenna 216 in B 17 RX state;

(vii) curve 614—LB diversity antenna 216 in B17 RX state, HB diversity antenna 218, FS isolation LB diversity-HB diversity;

(viii) curve 616—LB diversity antenna 216 in B17 RX state, FS isolation HB main-HB diversity;

(ix) curve 618—HB main antenna 214, LB diversity antenna 216 in B 17 RX state; and

(x) curve 620—LB diversity antenna 216 in B8 RX state, FS isolation LB diversity-LB main.

While the LB diversity antenna of the exemplary antenna apparatus used to obtain measurements shown in FIG. 6 is configured to operate only in the lowest (B17) and the highest (B8) LB RX bands, these bands represent the extreme cases for antenna switching, and it is expected that the bands B20, B5 (that lie in-between B17 and B8) will have at least similar performance as that shown in FIG. 6.

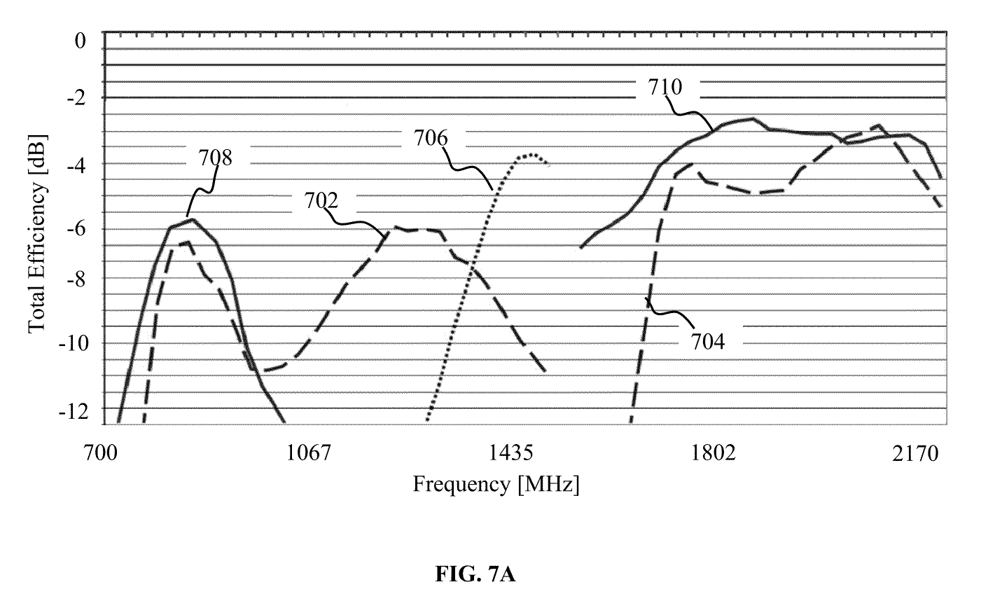

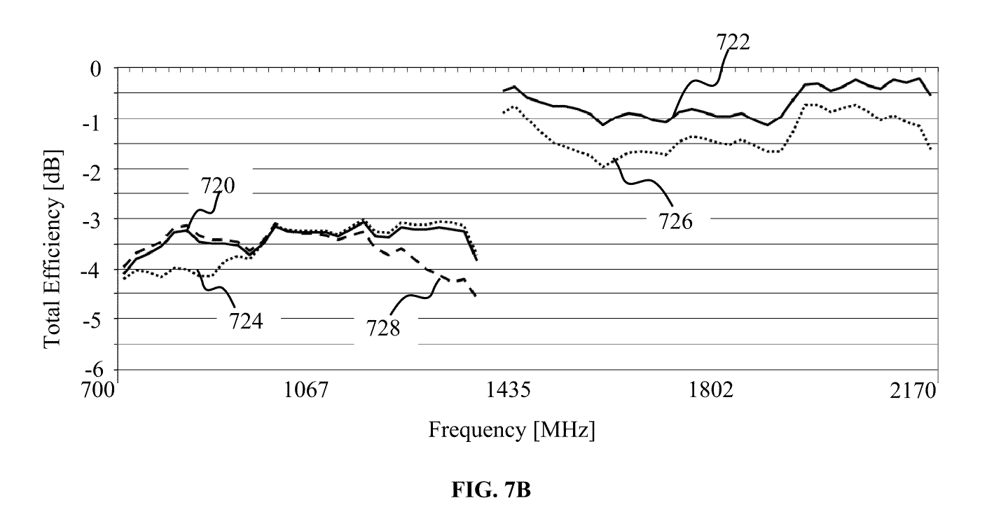

FIG. 7A presents data regarding measured free-space efficiency for the diversity antenna apparatus as described above with respect to FIG. 6 and comprising the LB diversity antenna 216 and the HB diversity antenna 218. Efficiency of an antenna (in dB) is defined as decimal logarithm of a ratio of radiated to input power:

$$AntennaEfficiency = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy.

The curves marked with designators 702-710 in FIG. 7A correspond to measurements obtained in the following antenna configurations: (i) curves 702, 704 relate to the passive diversity antenna of prior art used as a reference; (ii) curve 706 is taken with the LB diversity antenna 216 in B8 RX state, FS; and (iii) curves 708, 710 are taken with the LB diversity antenna 216 in B17 RX state, FS.

The data in FIG. 7A demonstrate that the active diversity antenna, constructed according with the principles of the present invention, offers an improved performance (as illustrated by higher total efficiency) in both the lower frequency range (curves 706, 708) and the higher frequency range (curve 710) compared to the passive diversity antenna of the prior art.

FIG. 7B presents data regarding measured free-space efficiency for the antenna apparatus configured as described above with respect to FIG. 6, and comprising four antennas 212, 214, 216, 218. The curves marked with designators 720-728 in FIG. 7B correspond to measurements obtained in the following antenna configurations: (i) curves 720, 722 are taken with the main antenna 212, 214; (ii) curves 724, 726 are taken with the main antenna 212, 214 and the LB diversity antenna in B17 RX state, FS; and (iii) curve 728 is taken with the main antenna 212, 214 and the LB diversity antenna in B8 RX state, FS. The data in FIG. 7B illustrate that the active diversity antenna implementation decreases main antenna efficiency by about 0.5 to 1 dB. HB efficiency change is most likely caused by additional cable added for the HB diversity antenna.

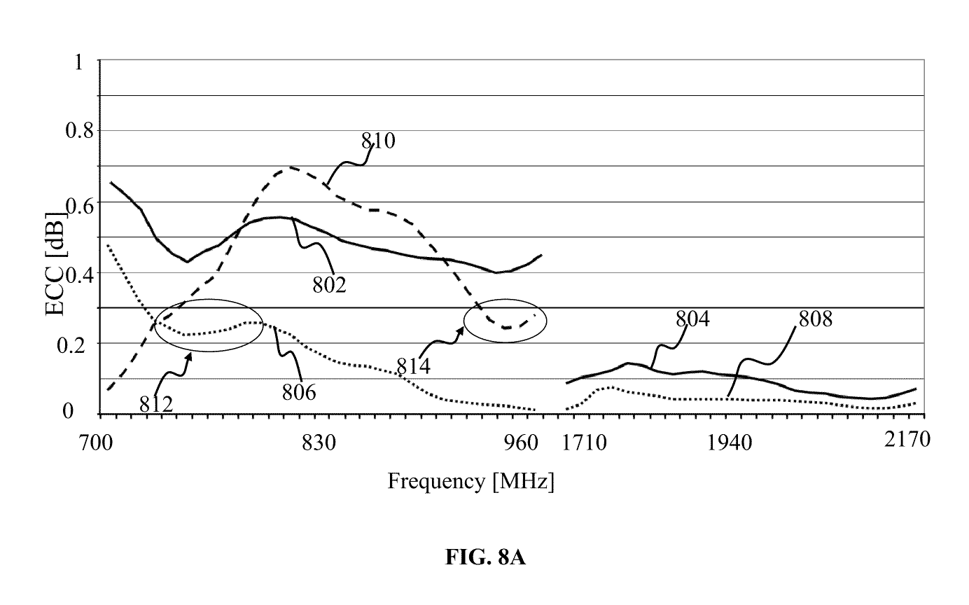

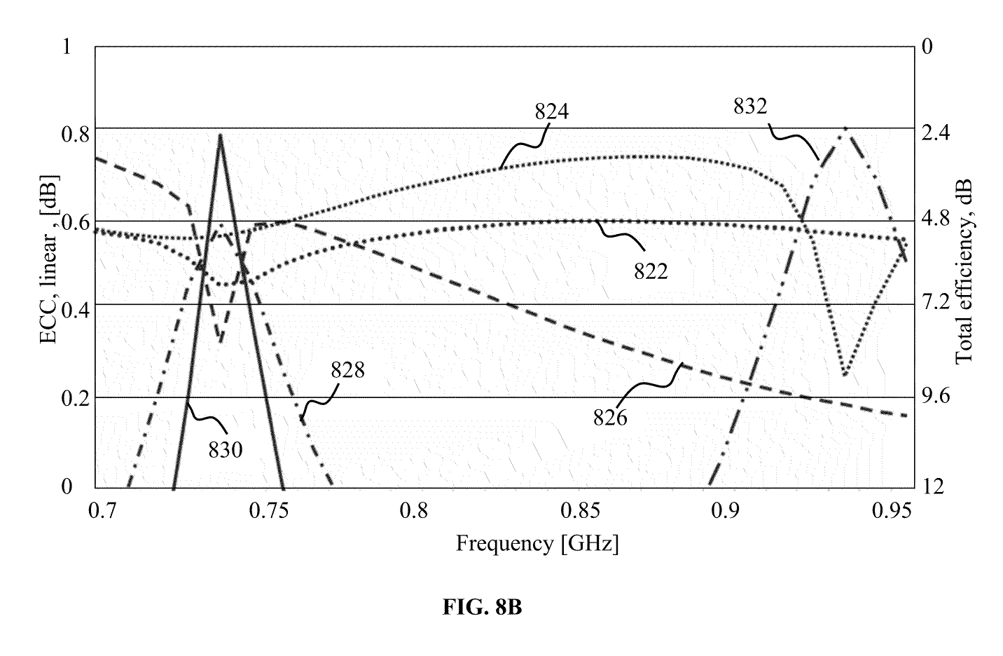

FIG. 8A presents data regarding envelope correlation n(ECC) measured with the antenna apparatus configured as described above with respect to FIG. 6, supra. The curves marked with designators 802-810 in FIG. 8A correspond to measurements obtained with the following configurations: (i) curves 802-804 are taken with the passive diversity antenna of prior art, used as a reference; (ii) curves 806-808 are taken with the LB diversity antenna 216 in B17 RX state and HB diversity antenna 218, FS; and (iii) curve 810 is taken with the LB diversity antenna 216 in B8 RX state, FS. The data in FIG. 8A demonstrate improved diversity antenna operation as indicated by a substantially lower ECC for the diversity antenna of the present invention (curves 806, 808) as compared to prior art (curves 802, 804), as indicated by the areas denoted by the arrows 812, 814 in FIG. 8A.

Test cables that are used during measurements (such as, for example, described with respect to FIG. 8A above) typically adversely affect antenna low band envelope correlation results; hence, model simulation is required to verify ECC behavior as compared to a passive antenna, as described below with respect to FIG. 8B.

FIG. 8B presents data regarding envelope correlation (ECC) obtained using simulations for the antenna configuration described above with respect to FIG. 6, supra. The curves marked with designators 822-832 in FIG. 8B correspond to data obtained for the following configurations: (i) curve 802 presents ECC data obtained for a passive diversity antenna of prior art and used as a reference for ECC performance comparison; (ii) curve 824 presents ECC data obtained for the LB diversity antenna 216 in B8 RX state; (iii) curve 826 presents ECC data obtained for the LB diversity antenna 216 in B17 RX state, FS; (iv) curve 828 presents total efficiency (TE) data obtained for a passive diversity antenna of prior art and used as a reference for TE performance comparison; (v) curve 830 presents TE data obtained for the LB diversity antenna 216 in B17 RX state; and (vi) curve 832 presents TE data obtained for the LB diversity antenna 216 in B8 RX state, FS.

The data in FIG. 8B demonstrate that the active diversity antenna, constructed according with the principles of the present invention, offers an improved performance (as illustrated by higher total efficiency and a lower ECC) compared to the passive diversity antenna of the prior art.

The data presented in FIGS. 4-8B demonstrate that active low band diversity antenna offers an improved performance over several widely spaced bands (e.g., the bands B17, B8) of the lower frequency range required by modern wireless communication networks. This capability advantageously allows operation of a portable computing or communication device with a single antenna over several mobile frequency bands such as B17, B20, B5, B8, and B13 using a single LB diversity antenna.

While the exemplary embodiments are described herein within the framework of LTE frequency bands, it is appreciated by those skilled in the arts that the principles of the present invention are equally applicable to constructing diversity antennas compatible with frequency configurations of other communications standards and systems, such as WCDMA and LTE-A, TD-LTE, etc.

Advantageously, the switched diversity antenna configuration (as in the illustrated embodiments described herein) further allows for improved device operation by reducing potential for antenna dielectric loading (and associated adverse effects) due to user handling, in addition to the aforementioned breadth and multiplicity of operating bands. Furthermore, the above improvements are accomplished without increasing the volume required by the diversity antennas and size of the mobile device.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. Diversity antenna apparatus, comprising:
a first antenna apparatus configured to operate in a first frequency range and comprising a first feed portion configured to be coupled to a feed structure of a radio device; and
a second antenna apparatus configured to operate in a second frequency range, and comprising:
a first radiator comprising a second feed portion configured to couple a radiating portion to said feed structure;
a second radiator comprising a first portion and a second portion, the second portion configured to be coupled to a ground plane of the radio device; and
selector apparatus configured to selectively couple said first portion to said ground plane;
wherein said selector apparatus is configured to enable wireless communication of the radio device in at least two operational bands within said second frequency range.

2. The apparatus of claim 1, wherein the at least two operational bands comprise bands specified by a Long Term Evolution (LTE) wireless communications standard.

3. The apparatus of claim 1, wherein said second frequency range is lower in frequency than said first frequency range.

4. The apparatus of claim 1, wherein first feed portion configured to be coupled to the feed structure forms at least a portion of a coupled-feed configuration, the coupled feed configuration enabling the diversity antenna apparatus to be substantially insensitive to dielectric loading during device operation.

5. The apparatus of claim 4, wherein said first and second frequency ranges do not appreciably overlap in frequency.

6. The apparatus of claim 1, wherein the selector apparatus comprises a switch.

7. The apparatus of claim 6, wherein the switch comprises a single pole, multi-throw switch.

8. A mobile communications device, comprising:
an enclosure comprising a plurality of sides;
an electronics assembly comprising a ground plane and at least one feed structure;
a main antenna assembly configured to operate in a lower frequency range and an upper frequency range and disposed proximate a bottom side of said plurality of sides; and
a diversity antenna assembly disposed along a lateral side of said plurality of sides, said lateral side being substantially perpendicular to said bottom side.

9. The mobile communication device of claim 8, wherein the diversity antenna assembly comprises:
a first diversity antenna apparatus configured to operate in the upper frequency range and comprising a first feed portion coupled to said feed structure; and
a second diversity antenna apparatus configured to operate in the lower frequency range, and comprising:
a first radiator comprising a second feed portion configured to couple a radiating portion to said feed structure;
a second radiator, comprising a ground structure coupled to the ground plane; and
a selector element configured to selectively couple a selector structure of said second radiator to said ground plane; and
wherein said selector element is configured to enable wireless communication of the mobile communication device in at least four operational bands within said lower frequency range.

10. The mobile communications device of claim 9, wherein:
said ground structure is disposed proximate a first end of the second diversity antenna apparatus; and
said second feed portion is disposed proximate a second end of the second diversity antenna apparatus, said second end disposed opposite from said first end.

11. The mobile communications device of claim 10, wherein said selector structure is disposed in-between said second feed portion and said ground structure.

12. The mobile communications device of claim 10, wherein said second feed portion is disposed proximate said first feed portion.

13. The mobile communications device of claim 10, wherein:
said second feed portion and said first feed portion are each coupled to a feed port via a feed cable; and
proximity of said second feed portion to said first feed portion is configured to reduce transmission losses in said feed cable.

14. The mobile communications device of claim 13, wherein, said feed cable comprises a microstrip conductor.

15. The mobile communications device of claim 13, wherein, said feed cable comprises a coaxial cable.

16. The mobile communications device of claim 9, wherein, said selector element comprises a switching apparatus characterized by a plurality of states and configured to selectively couple said selector structure to said ground plane via at least four distinct circuit paths.

17. The mobile communications device of claim 16, wherein at least one of said distinct circuit paths comprises a reactive circuit.

18. The mobile communications device of claim 9, wherein a first distance between the first feed portion and the second feed portion is less than a second distance between the second feed portion and said selector structure.

19. The mobile communications device of claim 9, wherein:
the second diversity antenna is characterized by a longitudinal dimension and a transverse dimension, the longitudinal dimension being greater than the transverse dimension;
the second radiator is configured substantially parallel to the longitudinal dimension;
the main antenna is disposed in an area characterized by a shorter dimension and a longer dimension; and
the longitudinal dimension is configured substantially perpendicular to the longer dimension.

20. The mobile communications device of claim 19, wherein:
the area comprises a rectangle;
the transverse dimensions is substantially perpendicular to the longitudinal dimension; and
the shorter dimension is substantially perpendicular to the longer dimension.

21. The mobile communications device of claim 9, wherein said second diversity antenna is characterized by a cross-section having a first dimension of no more than 2.8 mm.

22. Active low band diversity antenna apparatus, comprising:
at least first and second radiating elements; and
a coupled feed configuration;
wherein the coupled feed configuration enables the diversity antenna apparatus to be substantially insensitive to dielectric loading during device operation; and
wherein said antenna apparatus configured to operate over several spaced bands of a lower frequency range required by a wireless communication network standard.

23. The apparatus of claim 22, wherein the standard comprises a Long Term Evolution (LTE) standard, and the several spaced bands are selected from the B17, B20, B5, B8, and B13 bands thereof.

24. The apparatus of claim 23, further comprising switching apparatus in operative communication with said at least first and second radiating elements and configured to alter resonant frequency of the antenna apparatus.

25. A low frequency range diversity antenna comprising:
a coupling element;
a first radiating element being adapted for direct coupling to a feed structure of a portable device via the coupling element; and
a second radiating element being adapted for connection to a ground plane via at least one ground point;
wherein the diversity antenna is fed via the coupling element.

26. The antenna of claim 25, wherein the coupling element is disposed at approximately a center of an edge of the ground plane.

27. The antenna of claim 25, wherein a resonating portion of the low frequency range diversity antenna is formed by grounding a part of the antenna.
